(19) United States
(12) Patent Application Publication
(10) Pub. No.: US 2016/0179411 A1
(43) Pub. Date: Jun. 23, 2016

(54) Techniques to Provide Redundant Array of Independent Disks (RAID) Services Using a Shared Pool of Configurable Computing Resources

(71) Applicant: Intel Corporation, Santa Clara, CA (US)

(72) Inventors: Patrick Connor, PORTLAND, OR (US); Scott P. Dubal, Beaverton, OR (US); Ramamurthy Krithivas, Chandler, AZ (US); Chris Pavlas, Hillsboro, OR (US)

(73) Assignee: Intel Corporation, Santa Clara, CA (US)

(21) Appl. No.: 14/581,851

(22) Filed: Dec. 23, 2014

(51) Int. Cl. G06F 3/06; G06F 11/20

(52) U.S. Cl. CPC G06F 3/0619; G06F 3/0629; G06F 3/0689; G06F 11/2094; G06F 2201/805

(57) ABSTRACT

Examples may include techniques to provide redundant array of independent disks (RAID) services using a shared pool of configurable computing resources. Information for a data service being provided using the shared pool of configurable computing resources may be received. Logical servers hosting logical volume managers (LVMs) may be composed from at least a portion of the shared pool of configurable computing resources. In some examples, the hosted LVMs are capable of each providing a RAID service based, at least in part, on the received information for the data service.

### TECHNICAL FIELD

Examples described herein are generally related to configurable computing resources.

### BACKGROUND

Redundant array of independent disks (RAID) is a data storage virtualization technology that combines multiple storage components or devices (e.g., disk or solid state drives) into a logical block storage unit for purposes of data redundancy or performance. In some uses, data may be distributed across storage devices in various ways referred to as RAID levels. A given RAID level may depend on a desired level of redundancy and performance. Various RAID levels have separate schemes that each provides a different balance between reliability, availability, performance and capacity.

Software define infrastructure (SDI) is a technological advancement that enables new ways to operate a shared pool of configurable computing resources deployed for use in a data center or as part of a cloud infrastructure. SDI may allow individual elements of a system of configurable computing resources to be composed with software. These elements may include disaggregate physical elements such as CPUs, memory, network input/output devices or storage devices. The elements may also include composed elements that may include various quantities or combinations of physical elements composed to form logical servers that may then support virtual elements arranged to implement service/workload elements.

### BRIEF DESCRIPTION OF THE DRAWINGS

FIG. 1 illustrates an example first system.

FIG. 2 illustrates an example second system.

FIG. 3 illustrates an example first process.

FIG. 4 illustrates an example second process.

FIG. 5 illustrates an example third process.

FIG. 6 illustrates an example block diagram for an apparatus.

FIG. 7 illustrates an example of a logic flow.

FIG. 8 illustrates an example of a storage medium.

FIG. 9 illustrates an example computing platform.

### DETAILED DESCRIPTION

As contemplated in the present disclosure, SDI may allow individual elements of a shared pool of configurable computing resources to be composed with software. RAID may be a type of data storage virtualization technology that may possibly benefit from SDI. However, current RAID implementations may be restricted in that these implementations typically require physical disks in a given RAID array to reside on a same physical computer. Current RAID implementations may also be subject to physical distance constraints when drives for a RAID array may be interconnected via use of storage area network technologies such as serial attached SCSI (SAS) or fibre channel (FC). Maintaining a given RAID array on a same physical computer or limiting physical distances between drives may be problematic to a large shared pool of computing resources in a large data center that may include disaggregated physical elements disbursed throughout the large data center. It is with respect to these challenges that the examples described herein are needed.

According to some examples, techniques to provide RAID services using a shared pool of configurable computing resources may include receiving information for a data service being provided using a shared pool of configurable computing resources. The data service may include RAID services. The techniques may also include composing a plurality of logical servers such that each logical server includes at least a portion of the shared pool of configurable computing resources. The plurality of logical servers may be capable of separately hosting a logical volume manager (LVM) capable of providing a separate RAID service using at least a portion of the shared pool of configurable computing resources included with a respective logical server that hosts each LVM. The separate RAID service provided by each LVM may be based, at least in part, on the received information.

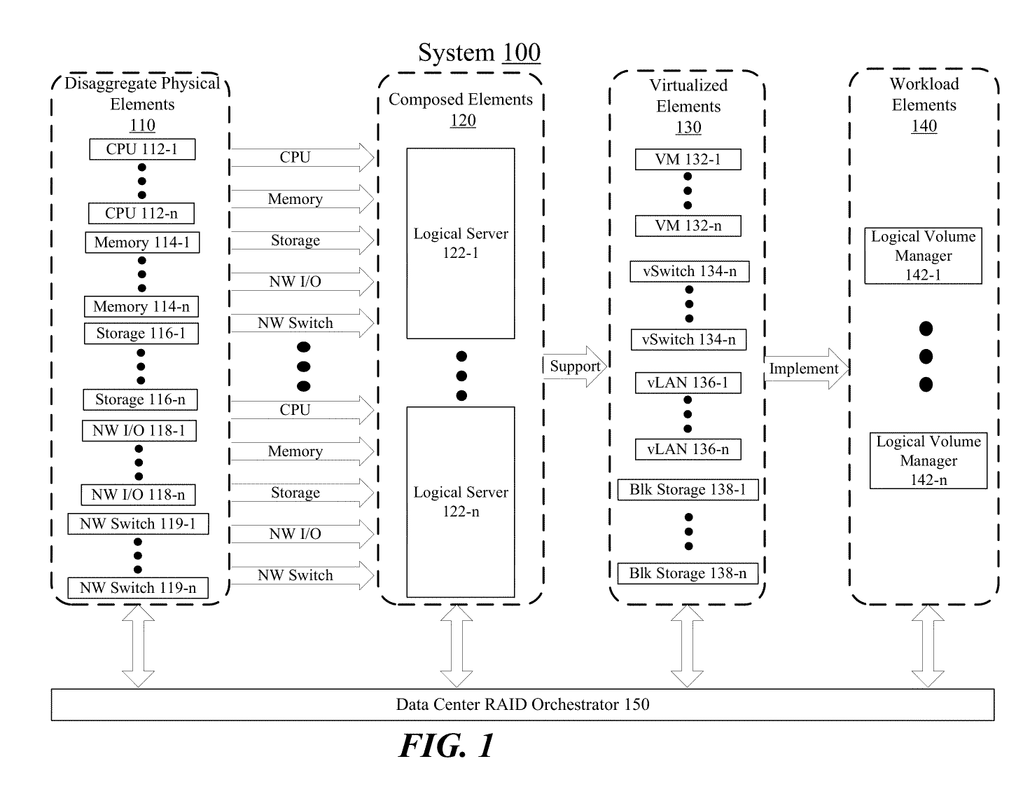

FIG. 1 illustrates an example first system. As shown in FIG. 1, the example first system includes system 100. In some examples, system 100 includes disaggregate physical elements 110, composed elements 120, virtualized elements 130 or workload elements 140. In some examples, data center RAID orchestrator (DRO) 150 may be arranged to manage or control at least some aspects of disaggregate physical elements 110, composed elements 120, virtualized elements 130 or workload elements 140. As described more below, in some examples, DRO manager 150 may receive information for a data service being provided using a shared pool of configurable computing resources that may include selected elements depicted in FIG. 1. The data service may include RAID services.

According to some examples, as shown in FIG. 1, disaggregate physical elements 110 may include CPUs 112-1 to 112-n, where “n” is any positive integer greater than 1. CPUs 112-1 to 112-n may individually represent single microprocessors or may represent separate cores of a multi-core microprocessor. Disaggregate physical elements 110 may also include memory 114-1 to 114-n. Memory 114-1 to 114-n may represent various types of memory devices such as, but not limited to, dynamic random access memory (DRAM) devices that may be included in dual in-line memory modules (DIMMs) or other configurations. Disaggregate physical elements 110 may also include storage 116-1 to 116-n. Storage 116-1 to 116-n may represent various types of storage devices such as hard disk drives or solid state drives. Disaggregate physical elements 110 may also include network (NW) input/outputs (I/Os) 118-1 to 118-n. NW I/Os 118-1 to 118-n may include network interface cards (NICs) having one or more NW ports w/associated media access control (MAC) functionality for network connections within system 100 or external to system 100. Disaggregate physical elements 110 may also include NW switches 119-1 to 119-n. NW switches 119-1 to 119-n may be capable of routing data via either internal or external network links for elements of system 100.

In some examples, as shown in FIG. 1, composed elements 120 may include logical servers 122-1 to 122-n. For these examples, groupings of CPU, memory, storage, NW I/O or NW switch elements from disaggregate physical elements may be composed to form logical servers 122-1 to 122-n. Each logical server may include any number or combination of CPU, memory, storage, NW I/O or NW switch elements.

According to some examples, as shown in FIG. 1, virtualized elements 130 may include VMs 132-1 to 132-n, vSwitches 134-1 to 134-n, vLANs 136-1 to 136-n or virtual storage volumes/block storage 138-1 to 138-n. For these examples, each of these virtualized elements may be supported by a given logical server from among logical servers 122-1 to 122-n of composed elements 120. For example, VM 132-1 may be supported by logical server 122-1 and may also be supported by disaggregate physical elements such as CPU 112-1 that may have been placed with logical server 122-1 following composition.

In some examples, virtualized elements 130 may be arranged to execute workload elements 140. As shown in FIG. 1, in some examples, workload elements 140 may include, but are not limited to, logical volume managers (LVMs) 142-1 to 142-n. For these examples, VMs, vSwitches, vLANs or block storage from virtualized elements 130 may be used to implement workload elements 140. For example, LVMs 142-1 to 142-n may use at least portions of block storage 136-1 to 136-n for implementing storage functionality for separate RAID services. LVMs 142-1 to 142-n may also use at least portions of VMs 132-1 to 132-n, vSwitches 134-1 to 134-n or vLANs 136-1 to 136-n for implementing compute functionality associated with providing the separate RAID services.

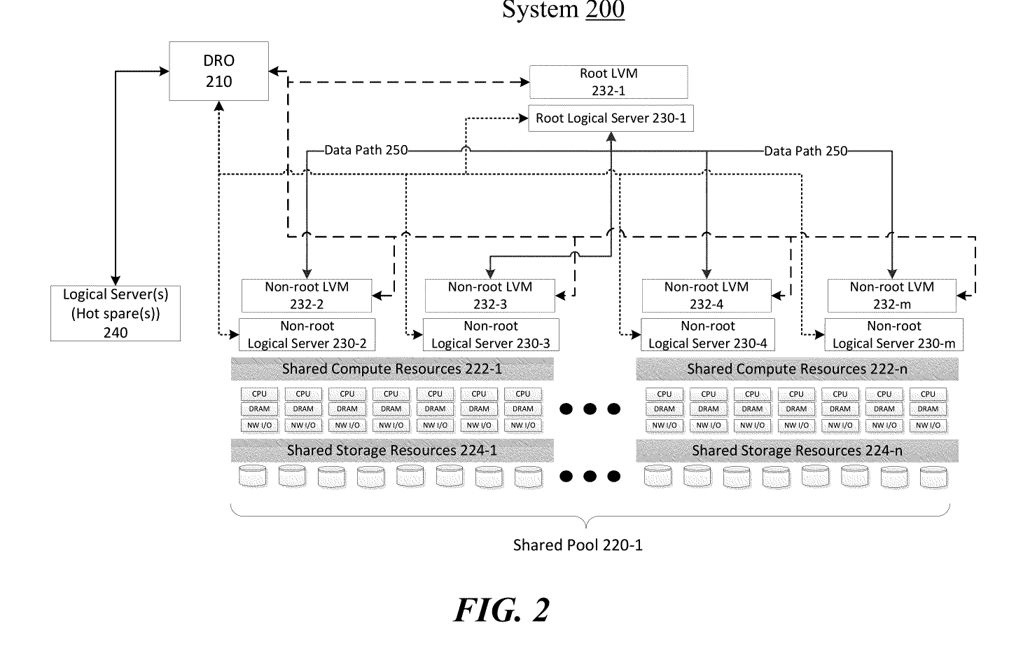

FIG. 2 illustrates an example second system. As shown in FIG. 2, the example first system includes system 200. In some examples, as shown in FIG. 2, system 200 includes a data center RAID orchestrator (DRO) 210 and shared pools 220-1 to 220-n. For these examples, FIG. 2 also shows that shared pool 220 includes shared compute resources 222-1 to 222-n and shared storage resources 224-1 to 224-n. Shared compute resources 222-1 to 222-n may include those disaggregate physical elements (PEs) configured for or related to compute functionality such as, but not limited to, CPUs, DRAM or NW I/O similar to disaggregate PEs 110 shown in FIG. 1. Shared storage resources 224-1 to 224-n may include those disaggregate PEs configured for or related to storage functionality such as, but not limited to, storage devices (e.g., hard disk drives (HDDs) or solid state drives (SSDs)) and controllers for these storage devices.

In some examples, controllers included in shared storage resources 224-1 to 224-n may be capable of using interconnect communication protocols described in industry standards or specifications (including progenies or variants) such as the Peripheral Component Interconnect (PCI) Express Base Specification, revision 3.0, published in November 2010 (“PCI Express” or “PCIe”) and/or the Non-Volatile Memory Express (NVMe) Specification, revision 1.1, published in October 2012. Other types of controllers may be arranged to operate according to such standards or specifications such as the Serial ATA (SATA) Specification, revision 3.2, published in August 2013 or Request for Comments (RFC) 3720, Internet SCSI (iSCSI), published in April 2004 or the SAS Specification, revision 2.1, published in December 2010.

According to some examples, DRO 210 may include logic and/or features to compose a plurality of logical servers that are shown in FIG. 2 as root or non-root logical servers 230-1 to 230-m, where “m” is any whole positive integer greater than 1. The dashed-lines indicate how DRO 210 may maintain communication channels with logical servers. For these examples, the logical servers may each be composed of at least a portion of shared computes resources 222-1 to 222-n and shared storage resources 224-1 to 224-n.

In some examples, root and non-root logical servers 230-1 to 230-m may be composed such that they are capable of respectively hosting root and non-root LVMs 232-1 to 232-m. For example, root logical server 230-1 may be capable of hosting root LVM 232-1 while non-root logical servers 230-2 to 230-m may be capable of hosting non-root LVMs 232-2 to 232-m. In order to host an LVM a given logical server may be composed to include adequate shared compute resources (e.g., CPU(s), DRAM(s) or NW I/O) and shared storage resources (e.g., HDD, SDD or controllers) to enable a hosted LVM to provide a RAID service. A given RAID service may be provided according to a service level agreement or service level objective (SLA/SLO) for one or more customers subscribing to a data service. DRO 210 may include logic and/or features capable of configuring root or non-root LVMs 232-1 to 232-m to provide the given RAID service. The dotted-lines indicate how DRO 210 may maintain communication channels with these LVMs.

Although not shown in FIG. 2, in some examples, logic and features of DRO 210 may also be hosted by a composed logical server that includes shared compute resources from among shared pool 220. For these examples, data center management controllers (not shown) may compose the logical server to host DRO 210. DRO 210 may then compose logical servers to host LVMs as mentioned above.

According to some examples, root logical server 230-1 may be designated as a root logical server based on a network hierarchy used to enable composed logical servers hosting LVMs to best meet SLA/SLO requirements. For example, root logical server 230-1 may be composed of shared computing resources from shared pool 220 that have an ability to meet all SLA/SLO requirements for a given customer. Composition may include selecting shared storage resources that are physically located in vicinity of or relatively close to each other and/or may be interconnected via links having minimal delays to support a RAID service provided by hosted root LVM 232-1. Located in vicinity of or relatively close may enable composition of the shared storage resources to keep composed logical servers in the vicinity of data in case of a possible failure or a reliability, availability and serviceability (RAS) event.

In some examples, data path 250 may be maintained between LVMs 232-1 to 232-m according to the network hierarchy used to meet SLA/SLO requirements. Those network hierarchy requirements may include enabling a failover between at least a first LVM arranged to provide a first RAID service to a second LVM also arranged to provide the first RAID service if a logical server hosting the first LVM fails or is no longer capable of supporting the first LVM or meeting the SLA/SLO requirements. For example, root LVM 232-1 may be configured to provide a RAID 5 data service and non-root LVM 232-2 may also be configured to provide the same RAID 5 data service. If root logical server 230-1 should fail, then non-root server 230-2 hosting non-root LVM 232-2 may failover and now become a root server hosting a root LVM to provide the same RAID 5 data service.

According to some examples, data path 250 may also be maintained using the network hierarchy to enable DRO 210 to dynamically reconfigure data path 250 between root and non-root LVMs 232-1 to 232-m due to a possible failure or a RAS event (e.g., defined by SLA/SLO). For example, data path 250 may be reconfigured responsive to a failure of a first data link between root LVM 232-1 and non-root LVM 232-4. A new, second data link may replace the first data link to maintain data path 250. For these examples, data path 250 may be either a transmission control protocol/internet protocol (TCP/IP) based network data path or a fabric based network data path. TCP/IP based network data path may operate according to the TCP/IP protocol described in Internet Engineering Task Force (IETF) Request for Comments (RFC) 791 and 793, published September 1981. The fabric based network may operate according to proprietary fabric protocols or based on one or more standards or specifications associated with Infiniband specifications including Infiniband Architecture Specification, Volume 1, Release 1.2.1, published in November 2007 (“the Infiniband Architecture specification”).

In some examples, an LVM hierarchy may also be established such that composed logical servers may host LVMs providing RAID services with different redundancy characteristics. These different redundancy characteristics may include assigning hot spares to each root or non-root logical server. For these examples, DRO 210 may compose one or more logical server(s) 240 as hot spares using at least a portion of shared compute resources 222-1 to 222-n and shared storage resources 224-1 to 224-n. Logical server(s) 240 may be configured to provide redundant logical servers to an assigned root or non-root logical server. For example, a logical server from among logical server(s) 240 may be arranged as a hot spare for root logical server 230-1 hosting root LVM 232-1. If composed components of root logical server 230-1 should fail or fall below performance requirements (e.g., according to SLA/SLO requirements), the hot spare logical server may be capable of taking over as either a host for root LVM 232-1 or may be capable of hosting another LVM capable of providing a same RAID service as was provided by LVM 232-1.

Different redundancy characteristics for providing RAID services may also include DRO 210 configuring at least some of the LVMs to provide different RAID levels. For example, root LVM 232-1 may be configured to provide a high RAID level such as RAID 6 (block-level striping with double distributed parity) while at least some other LVMs may be configured to provide lower, less redundant RAID levels such as RAID 5 (block-level striping with distributed parity).

Different redundancy characteristics for providing RAID services may also include DRO 210 configuring at least some of the LVMs having different volume expansion capabilities. For example, root LVM 232-1 may have a first, higher volume expansion capability compared to at least some of non-root LVMs 232-2 to LVMs 232-m. The higher volume expansion capability may enable root LVM 232-1 to support higher levels of redundancy when providing a RAID service due to an ability to expand a number of storage devices for providing that RAID service.

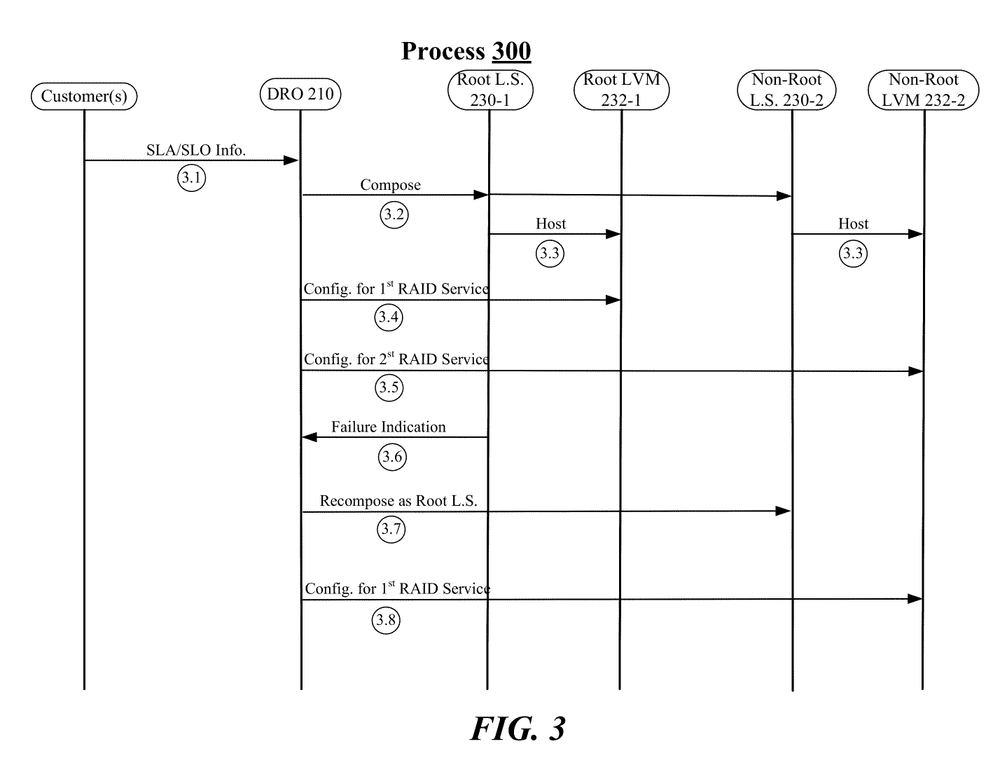

FIG. 3 illustrates an example first process 300. As shown in FIG. 3, the first process includes process 300. According to some examples, process 300 may be for providing RAID services using a shared pool of configurable computing resources. For these examples, at least some components of system 200 shown in FIG. 2 may be related to process 300. However, the example process 300 is not limited to implementations using components of system 200 shown or described in FIG. 2.

Starting at process 3.1 (SLA/SLO Info.), DRO 210 may include logic and/or features to receive SLA/SLO information from one or more customers of a data service that may be provided using a shared pool of configurable computing resources deployed within a data center. The data service may include RAID services and the SLA/SLO information may include configuration requirements for providing the RAID services (e.g., types of storage devices). The SLA/SLO information may also include customer-specific RAS requirements to meet while providing the RAID services and/or definitions of what constitutes a RAS event. The shared pool of configurable computing resources, for example, may be selected from shared pool 220.

Moving to process 3.2 (Compose), DRO 210 may include logic and/or features to compose root logical server (L.S.) 230-1 and non-root L.S. 230-2 such that these logical servers include at least a portion of the shared pool of configurable computing resources.

Moving to process 3.3 (Host), both root L.S. 230-1 and non-root L.S. 230-2 may be capable of separately hosting respective root LVM 232-1 and non-root LVM 232-2.

Moving to process 3.4 (Config. for 1^{st} RAID Service), DRO 210 may include logic and/or features to configure root LVM 232-1 to provide a first RAID service (e.g., RAID 6).

Moving to process 3.5 (Config. for 2^{nd} RAID Service), DRO 210 may include logic and/or features to configure non-root LVM 232-2 to provide a second RAID service (e.g., RAID 5).

Moving to process 3.6 (Failure Indication), DRO 210 may include logic and/or features to receive an indication of a failure by root L.S. 230-1. In some examples, the failure may be due to one or more configurable computing resources used to compose root L.S. 230-1 have either failed, became unstable or became unresponsive.

Moving to process 3.7 (Recompose as Root L.S.), DRO 210 may include logic and/or features to recompose non-root L.S. 230-2 to become a root L.S.

Moving process 3.8 (Config. for 1^{st} RAID Service), DRO 210 may include logic and/or features to then reconfigure recomposed root L.S. 230-2 to provide the first RAID service. The process may then come to an end.

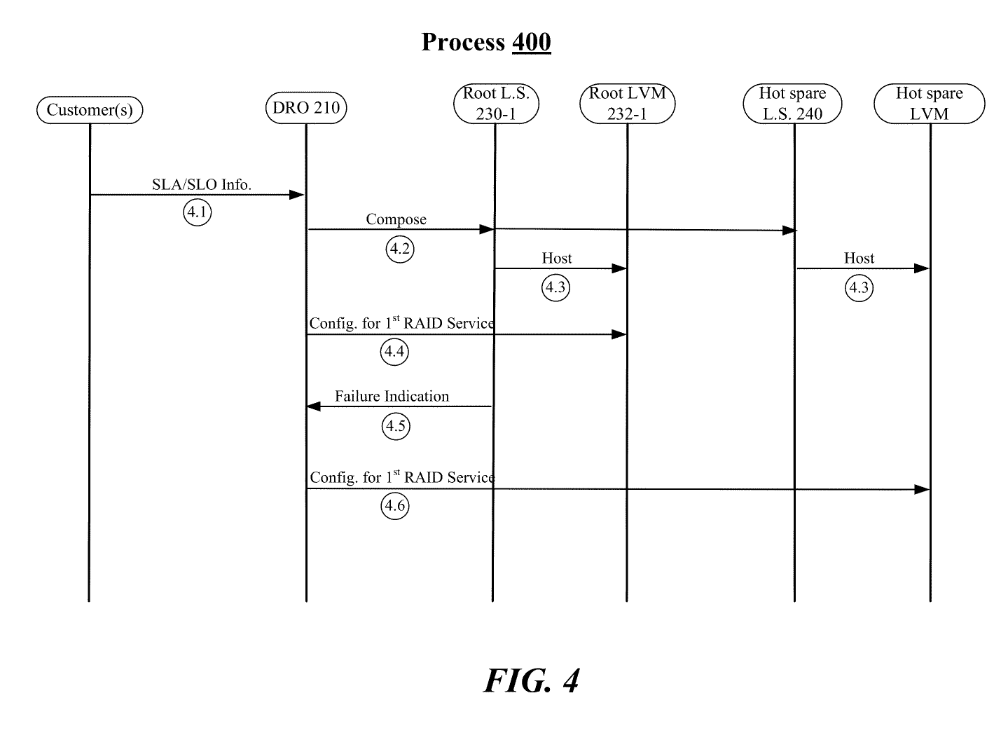

FIG. 4 illustrates an example second process 400. As shown in FIG. 4, the second process includes process 400. Similar to process 300, process 400 may be for providing RAID services using a shared pool of configurable computing resources. For these examples, at least some components of system 200 shown in FIG. 2 may be related to process 400. However, the example process 400 is not limited to implementations using components of system 200 shown or described in FIG. 2.

Starting at process 4.1 (SLA/SLO Info.), DRO 210 may include logic and/or features to receive SLA/SLO information from one or more customers of a data service that may be provided using a shared pool of configurable computing resources deployed within a data center. The data service may include RAID services and the SLA/SLO information may include configuration requirements for providing the RAID services or customer-specific RAS requirements to meet while providing the RAID services and/or definitions of what constitutes a RAS event. The shared pool of configurable computing resources, for example, may be selected from shared pool 220.

Moving to process 4.2 (Compose), DRO 210 may include logic and/or features to compose root logical server (L.S.) and host spare L.S. 240 such that these logical servers include at least a portion of the shared pool of configurable computing resources.

Moving to process 4.3 (Host), root L.S. 230-1 may be capable of hosting LVM 232-1 and hot spare L.S. 240 may be capable of hosting a hot spare LVM.

Moving to process 4.4 (Config. for 1^{st} RAID Service), DRO 210 may include logic and/or features to configure root LVM 232-1 to provide a first RAID service (e.g., RAID 6).

Moving to process 4.5 (Failure Indication), DRO 210 may include logic and/or features to receive an indication of a failure by root L.S. 230-1.

Moving process 4.6 (Config. for 1^{st} RAID Service), DRO 210 may include logic and/or features to configure the hot spare LVM hosted by host spare L.S. 240 for the first RAID service. In some examples, hot spare L.S. 240 may be designated as the root L.S. and the hot spare LVM may be designated as the root LVM. The process may then come to an end.

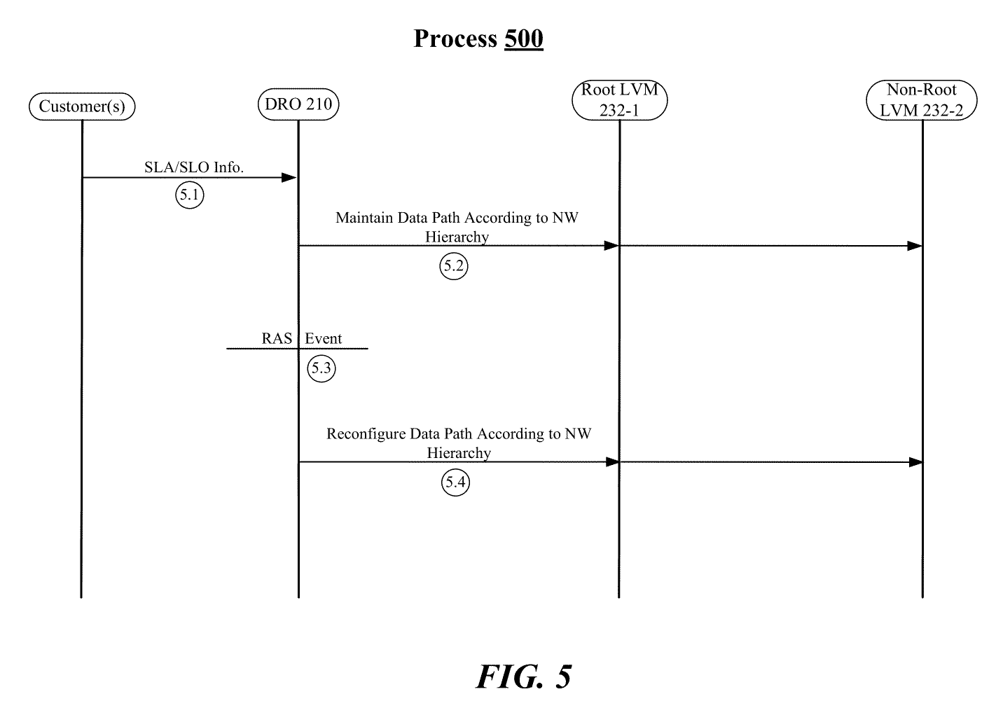

FIG. 5 illustrates an example third process 500. As shown in FIG. 5, the third process includes process 500. Process 500 may be associated with providing RAID services using a shared pool of configurable computing resources. For these examples, at least some components of system 200 shown in FIG. 2 may be related to process 500. However, the example process 500 is not limited to implementations using components of system 200 shown or described in FIG. 2.

Starting at process 5.1 (SLA/SLO Info.), DRO 210 may include logic and/or features to receive SLA/SLO information from one or more customers of a data service that may be provided using a shared pool of configurable computing resources deployed within a data center. The data service may include RAID services and the SLA/SLO information may include configuration requirements for providing the RAID services or customer-specific RAS requirements to meet while providing the RAID services and/or definitions of what constitutes a RAS event. The RAS requirements or definitions may include, but are not limited to, packet latencies thresholds, packet drop rate thresholds, data throughput thresholds, logical server response latency thresholds, availability of redundant or hot spare logical server(s), storage device read/write rate thresholds, available storage thresholds. The shared pool of configurable computing resources, for example, may be selected from shared pool 220.

Moving to process 5.2 (Maintain Data Path According to NW Hierarchy), DRO 210 may include logic and/or feature to maintain data path 250 between root LVM 232-1 and non-root LVM 232-2 such that a network hierarchy is established to enable a possible failover between root LVM 232-1 and non-root LVM 232-2.

Moving to process 5.3 (RAS Event), DRO 210 may include logic and/or features to detect or receive an indication of a RAS event. In some examples, the RAS event may result in deeming a first data link between root LVM 232-1 and non-root LVM 232-2 as failing or no longer acceptable. For example, a switch associated with the first data link may become overly congested and may result in unacceptable latencies for data path 250. In other examples, the first data link may physically fail or may be taken off-line (e.g., either physically or logically disconnected from a NW I/O port).

Moving to process 5.4 (Reconfigure Data Path According to NW Hierarchy), DRO 210 may include logic and/or features to reconfigure data path 250 between root LVM 232-1 and non-root LVM 232-2 to include a new or different link to compensate for the failure of the first link. In some examples, the new or different link may need to be established to still meet SLA/SLO requirements. The process then comes to an end.

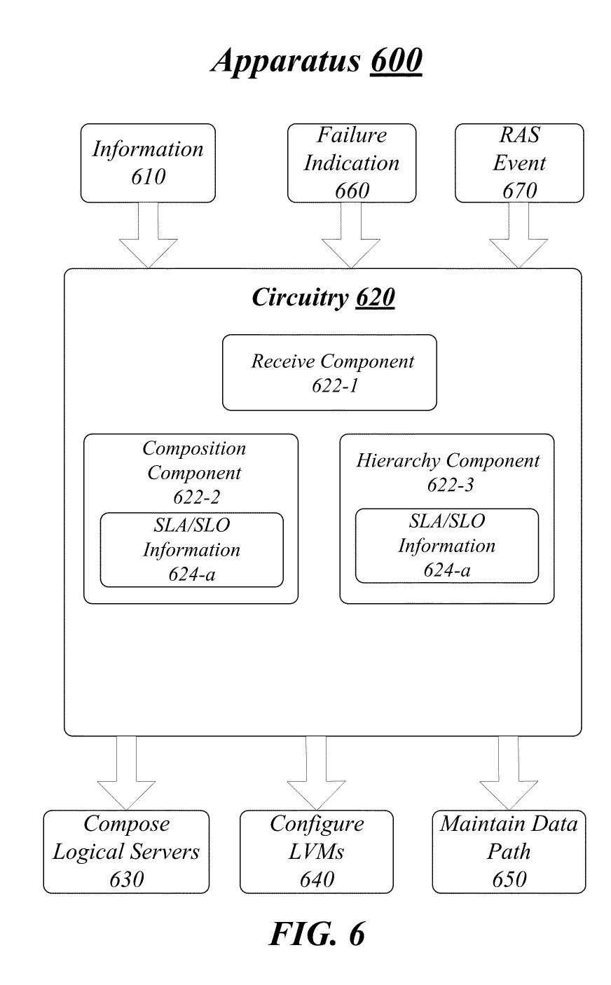

FIG. 6 illustrates an example block diagram for apparatus 600. Although apparatus 600 shown in FIG. 6 has a limited number of elements in a certain topology, it may be appreciated that the apparatus 600 may include more or less elements in alternate topologies as desired for a given implementation.

According to some examples, apparatus 600 may be supported by circuitry 620 maintained at or with management elements for a system including a shared pool of configurable computing resources such as DRO 150 shown in FIG. 1 for system 100 or DRO 210 shown in FIG. 2 for system 200. Circuitry 620 may be arranged to execute one or more software or firmware implemented modules or components 622-a. It is worthy to note that “a” and “b” and “c” and similar designators as used herein are intended to be variables representing any positive integer. Thus, for example, if an implementation sets a value for a=3, then a complete set of software or firmware for components 622-a may include components 622-1, 622-2 or 622-3. The examples presented are not limited in this context and the different variables used throughout may represent the same or different integer values. Also, these “components” may be software/firmware stored in computer-readable media, and although the components are shown in FIG. 6 as discrete boxes, this does not limit these components to storage in distinct computer-readable media components (e.g., a separate memory, etc.).

According to some examples, circuitry 620 may include a processor, processor circuit or processor circuitry. Circuitry 620 may be part of host processor circuitry that supports a management element for cloud infrastructure such as DRO 150 or DRO 210. Circuitry 620 may be generally arranged to execute one or more software components 622-a. Circuitry 620 may be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 620 may also include an application specific integrated circuit (ASIC) and at least some components 622-a may be implemented as hardware elements of the ASIC.

In some examples, apparatus 600 may include a receive component 622-1. Receive component 622-1 may be executed by circuitry 620 to receive information for a data service being provided using a shared pool of configurable computing resources, the data service including RAID services. For these examples, information 610 may include the received information. Information 610 may include SLA/SLO information associated with one or more customers for which the RAID services are being provided.

According to some examples, apparatus 600 may also include a composition component 622-2. Composition component 622-2 may be executed by circuitry 620 to compose a plurality of logical servers such that each logical server includes at least a portion of the shared pool of configurable computing resources. For these examples, the plurality of logical servers may be capable of separately hosting an LVM capable of providing a separate RAID service using at least a portion of the shared pool of configurable computing resources included with a respective logical server that hosts each LVM. The separate RAID service provided by each LVM may be based, at least in part, on the received information. In some examples, SLA/SLO information 624-a (e.g., maintained in a lookup table (LUT)) may include the received information. Compose logical servers 630 as shown in FIG. 6 may indicate the composing of the plurality of servers by composition component 622-2.

In some examples, composition component 622-2 may also configure LVMs hosted by composed logical services to provide RAID services having different redundancy characteristics such as providing different RAID levels or different volume expansion capabilities based on the received information. Configure LVMs 640, as shown in FIG. 6, may indicate the configuring of the LVMs by composition component 622-2.

According to some examples, apparatus 600 may also include a hierarchy component 622-3. Hierarchy component 622-3 may be executed by circuitry 620 to maintain a data path between each LVM such that a network hierarchy is established to enable failover between at least a first LVM arranged to provide a first RAID service to a second LVM also arranged to provide the first RAID service if a logical server hosting the first LVM fails or is no longer capable of supporting the first LVM. For these examples, hierarchy component 622-3 may use SLA/SLO information 624-a to determine the network hierarchy and maintain the data path. Maintain data path 650, as shown in FIG. 6, may indicate the maintaining of the data path by hierarchy component 622-3.

In some examples, hierarchy component 622-3 may also maintain the data path using the network hierarchy to reconfigure the data path between the first LVM and the second LVM responsive to a failure of a first data link between the first and second LVMs. For these examples, failure indication 660 or RAS event 670 may indicate the failure of the first data link. SLA/SLO information 624-a may be used to determine an alternative data link to reconfigure the data path. SLA/SLO information 624-a may also include definitions or criteria for hierarchy component 622-3 to determine what is or is not a RAS event (.g., packet latencies thresholds, packet drop rate thresholds, data throughput thresholds, logical server response latency thresholds, availability of redundant or hot spare logical server(s), storage device read/write rate thresholds, available storage thresholds, etc.).

Various components of apparatus 600 and a device, node or logical server implementing apparatus 600 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

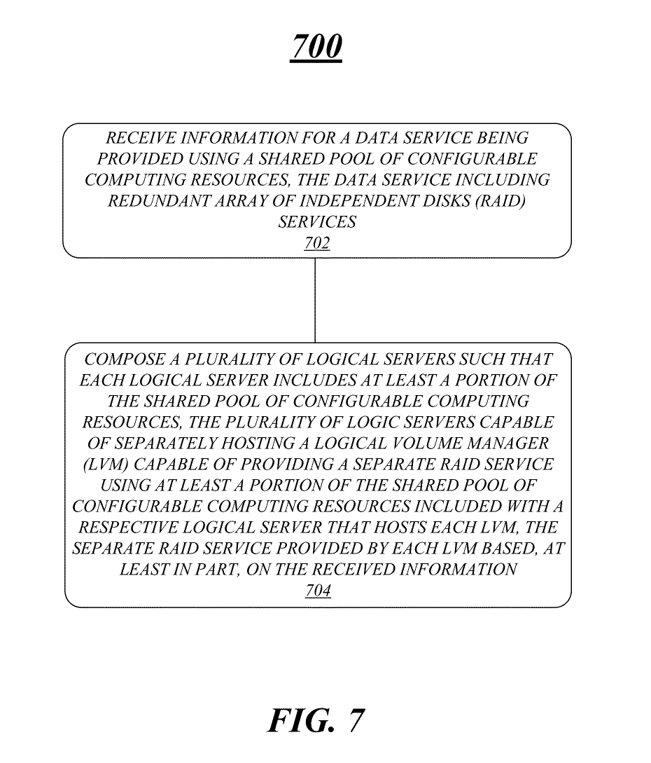

FIG. 7 illustrates an example logic flow 700. Logic flow 700 may be representative of some or all of the operations executed by one or more logic, features, or devices described herein, such as apparatus 600. More particularly, logic flow 700 may be implemented by at least receive component 622-1 or composition component 622-2.

According to some examples, logic flow 700 at block 702 may receive information for a data service being provided using a shared pool of configurable computing resources, the data service including RAID services. For these examples, receive component 622-1 may receive the information.

In some examples, logic flow 700 at block 704 may compose a plurality of logical servers such that each logical server includes at least a portion of the shared pool of configurable computing resources, the plurality of logical servers capable of separately hosting an LVM capable of providing a separate RAID service using at least a portion of the shared pool of configurable computing resources included with a respective logical server that hosts each LVM, the separate RAID service provided by each LVM based, at least in part, on the received information. For these examples, composition component 622-2 may compose the plurality of logical servers.

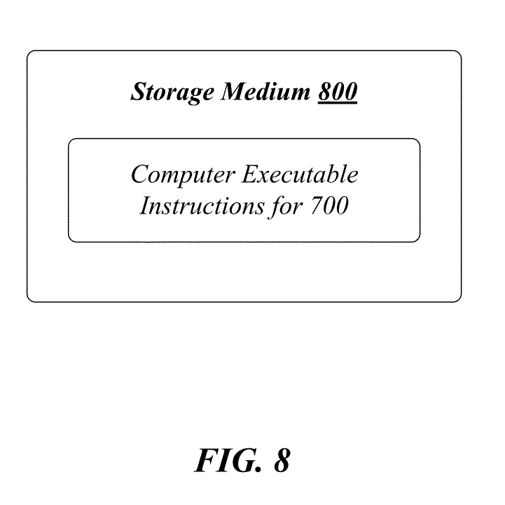

FIG. 8 illustrates an example storage medium 800. As shown in FIG. 8, the first storage medium includes a storage medium 800. The storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions to implement logic flow 700. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

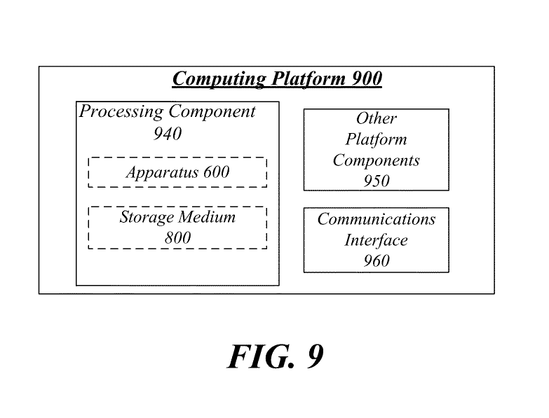

FIG. 9 illustrates an example computing platform 900. In some examples, as shown in FIG. 9, computing platform 900 may include a processing component 940, other platform components 950 or a communications interface 960. According to some examples, computing platform 900 may host management elements (e.g., data center RAID orchestrator) providing management functionality for a system having a shared pool of configurable computing resources such as system 100 of FIG. 1 or system 200 of FIG. 2. Computing platform 900 may either be a single physical server or a composed logical server that includes combinations of disaggregate components or elements composed from a shared pool of configurable computing resources.

According to some examples, processing component 940 may execute processing operations or logic for apparatus 600 and/or storage medium 800. Processing component 940 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 950 may include common computing elements, such as one or more processors, multi-core processors, co-processors, memory units, chipsets, controllers, peripherals, interfaces, oscillators, timing devices, video cards, audio cards, multimedia input/output (I/0) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 960 may include logic and/or features to support a communication interface. For these examples, communications interface 960 may include one or more communication interfaces that operate according to various communication protocols or standards to communicate over direct or network communication links. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Hardware Abstraction API Specification. Network communications may also occur according to the Infiniband Architecture specification or the TCP/IP protocol.

As mentioned above computing platform 900 may be implemented in a single server or a logical server made up of composed disaggregate components or elements for a shared pool of configurable computing resources. Accordingly, functions and/or specific configurations of computing platform 900 described herein, may be included or omitted in various embodiments of computing platform 900, as suitably desired for a physical or logical server.

The components and features of computing platform 900 may be implemented using any combination of discrete circuitry, application specific integrated circuits (ASICs), logic gates and/or single chip architectures. Further, the features of computing platform 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

Example 1. An example apparatus may include circuitry and a receive component for execution by the circuitry to receive information for a data service being provided using a shared pool of configurable computing resources, the data service including RAID services. The apparatus may also include a composition component for execution by the circuitry to compose a plurality of logical servers such that each logical server includes at least a portion of the shared pool of configurable computing resources. For these examples, the plurality of logical servers may be capable of separately hosting an LVM capable of providing a separate RAID service using at least a portion of the shared pool of configurable computing resources included with a respective logical server that hosts each LVM. The separate RAID service may be provided by each LVM based, at least in part, on the received information.

Example 2. The apparatus of example 1, the received information for the data service may include a service level agreement or service level objective for one or more customers of the data service.

Example 3. The apparatus of example 1, the composition component may configure at least some of the LVMs such that a first LVM capable of providing a first RAID service may be arranged to be a hot spare for a second LVM currently providing the first RAID service.

Example 4. The apparatus of example 1, the composition component to compose the plurality of logical servers may include the composition component to configure at least some of the logical servers such that a first logical server hosting a first LVM capable of providing a first RAID service may be arranged to be a hot spare for a second logical server hosting a second LVM currently providing the first RAID service.

Example 5. The apparatus of example 1, the composition component may configure at least some of the LVMs to provide RAID services having different redundancy characteristics such that a first LVM provides a first RAID service having a first volume expansion capability and a second LVM provides a second RAID service having a second, different volume expansion capability.

Example 6. The apparatus of example 1 may also include a hierarchy component for execution by the circuitry that may maintain a data path between each LVM such that a network hierarchy is established to enable failover between at least a first LVM arranged to provide a first RAID service to a second LVM also arranged to provide the first RAID service if a logical server hosting the first LVM fails or is no longer capable of supporting the first LVM.

Example 7. The apparatus of example 6, the hierarchy component may also maintain the data path using the network hierarchy to reconfigure the data path between the first LVM and the second LVM responsive to a failure of a first data link between the first and second LVMs.

Example 8. The apparatus of example 7, the failure of the logical server hosting the first LVM or the failure of the first data link may be based on a RAS event defined, at least in part, in the received information for the data service.

Example 9. The apparatus of example 6, the data path may include a TCP/IP based network data path or a fabric based network data path.

Example 10. The apparatus of example 1, the shared pool of configurable computing resources may include disaggregate physical elements such as central processing units, memory devices, storage devices, network input/output devices or network switches.

Example 11. The apparatus of example 10, providing the separate RAID service using at least the portion of the shared pool of configurable computing resources included with the respective logical server that hosts each LVM may include the at least a portion including one or more storage devices arranged as a solid state drive or a hard disk drive.

Example 12. The apparatus of example 1 may also include a digital display coupled to the circuitry to present a user interface view.

Example 13. An example method may include receiving, at a processor circuit, information for a data service being provided using a shared pool of configurable computing resources, the data service including RAID services. The method may also include composing a plurality of logical servers such that each logical server includes at least a portion of the shared pool of configurable computing resources. The plurality of logical servers may be capable of separately hosting an LVM capable of providing a separate RAID service using at least a portion of the shared pool of configurable computing resources included with a respective logical server that hosts each LVM. The separate RAID service may be provided by each LVM based, at least in part, on the received information.

Example 14. The method of example 13, the received information for the data service may include a service level agreement or service level objective for one or more customers of the data service.

Example 15. The method of example 13 may also include configuring at least some of the LVMs to provide RAID services having different redundancy characteristics such that a first LVM provides a first RAID service having a first RAID level and a second LVM provides a second RAID service having a second, different RAID level.

Example 16. The method of example 13, composing the plurality of logical servers may include configuring at least some of the logical servers such that a first logical server hosting a first LVM capable of providing a first RAID service may be arranged to be a hot spare for a second logical server hosting a second LVM currently providing the first RAID service.

Example 17. The method of example 13 may also include configuring at least some of the LVMs to provide RAID services having different redundancy characteristics such that a first LVM provides a first RAID service having a first volume expansion and a second LVM provides a second RAID service having a second, different volume expansion.

Example 18. The method of example 13 may also include maintaining a data path between each LVM such that a network hierarchy is established to enable failover between at least a first LVM arranged to provide a first RAID service to a second LVM also arranged to provide the first RAID service if a logical server hosting the first LVM fails or is no longer capable of supporting the first LVM.

Example 19. The method of example 18, maintaining the data path using the network hierarchy to reconfigure the data path between the first LVM and the second LVM responsive to a failure of a first data link between the first and second LVMs.

Example 20. The method of example 19, the failure of the logical server hosting the first LVM or the failure of the first data link may be based on a RAS event defined, at least in part, in the received information for the data service.

Example 21. The method of example 18, the data path may include a TCP/IP based network data path or a fabric based network data path.

Example 22. The method of example 13, the shared pool of configurable computing resources may include disaggregate physical elements such as central processing units, memory devices, storage devices, network input/output devices or network switches.

Example 23. The method of example 22, providing the separate RAID service using at least the portion of the shared pool of configurable computing resources included with the respective logical server that hosts each LVM may include the at least a portion including one or more storage devices arranged as a solid state drive or a hard disk drive.

Example 24. An example at least one machine readable medium may include a plurality of instructions that in response to being executed by system at a server may cause the system to carry out a method according to any one of examples 13 to 23.

Example 25. An example apparatus may include means for performing the methods of any one of examples 13 to 23.

Example 26. An example at least one machine readable medium may include a plurality of instructions that in response to being executed by system may cause the system to receive information for a data service being provided using a shared pool of configurable computing resources, the data service including RAID services. The instructions may also cause the system to compose a plurality of logical servers such that each logical server includes at least a portion of the shared pool of configurable computing resources. The plurality of logical servers may be capable of separately hosting an LVM capable of providing a separate RAID service using at least a portion of the shared pool of configurable computing resources included with a respective logical server that hosts each LVM. The separate RAID service may be provided by each LVM based, at least in part, on the received information.

Example 27. The at least one machine readable medium of example 26, the received information for the data service may include a service level agreement or service level objective for one or more customers of the data service.

Example 28. The at least one machine readable medium of example 26, the instructions may further cause the system to configure at least some of the LVMs to provide RAID services having different redundancy characteristics such that a first LVM provides a first RAID service having a first RAID level and a second LVM provides a second RAID service having a second, different RAID level.

Example 29. The at least one machine readable medium of example 29, the instructions to cause the system to compose the plurality of logical servers may include the instructions to also cause the system to configure at least some of the logical servers such that a first logical server hosting a first LVM capable of providing a first RAID service is arranged to be a hot spare for a second logical server hosting a second LVM currently providing the first RAID service.

Example 30. The at least one machine readable medium of example 26, the instructions may further cause the system to configure at least some of the LVMs to provide RAID services having different redundancy characteristics such that a first LVM provides a first RAID service having a first volume expansion and a second LVM provides a second RAID service having a second, different volume expansion.

Example 31. The at least one machine readable medium of example 26, the instructions may further cause the system to maintain a data path between each LVM such that a network hierarchy may be established to enable failover between at least a first LVM arranged to provide a first RAID service to a second LVM also arranged to provide the first RAID service if a logical server hosting the first LVM fails or is no longer capable of supporting the first LVM.

Example 32. The at least one machine readable medium of example 31, the instructions may cause the system to maintain the data path using the network hierarchy to reconfigure the data path between the first LVM and the second LVM responsive to a failure of a first data link between the first and second LVMs.

Example 33. The at least one machine readable medium of example 32, the failure of the logical server hosting the first LVM or the failure of the first data link may be based on a RAS event defined, at least in part, in the received information for the data service.

Example 34. The at least one machine readable medium of example 31, the data path may include a TCP/IP based network data path or a fabric based network data path.

Example 35. The at least one machine readable medium of example 26, the shared pool of configurable computing resources may include disaggregate physical elements such as central processing units, memory devices, storage devices, network input/output devices or network switches.

Example 36. The at least one machine readable medium of example 35, the instructions may cause the system to provide the separate RAID service using the at least the portion of the shared pool of configurable computing resources included with the respective logical server that hosts each LVM comprises the at least a portion including one or more storage devices arranged as a solid state drive or a hard disk drive.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
circuitry;
a receive component for execution by the circuitry to receive information for a data service being provided using a shared pool of configurable computing resources, the data service including redundant array of independent disks (RAID) services; and
a composition component for execution by the circuitry to compose a plurality of logical servers such that each logical server includes at least a portion of the shared pool of configurable computing resources, the plurality of logical servers capable of separately hosting a logical volume manager (LVM) capable of providing a separate RAID service using at least a portion of the shared pool of configurable computing resources included with a respective logical server that hosts each LVM, the separate RAID service provided by each LVM based, at least in part, on the received information.

2. The apparatus of claim 1, the received information for the data service including a service level agreement or service level objective for one or more customers of the data service.

3. The apparatus of claim 1, comprising the composition component to configure at least some of the LVMs such that a first LVM capable of providing a first RAID service is arranged to be a hot spare for a second LVM currently providing the first RAID service.

4. The apparatus of claim 1, the composition component to compose the plurality of logical servers comprises the composition component to configure at least some of the logical servers such that a first logical server hosting a first LVM capable of providing a first RAID service is arranged to be a hot spare for a second logical server hosting a second LVM currently providing the first RAID service.

5. The apparatus of claim 1, comprising the composition component to configure at least some of the LVMs to provide RAID services having different redundancy characteristics such that a first LVM provides a first RAID service having a first volume expansion capability and a second LVM provides a second RAID service having a second, different volume expansion capability.

6. The apparatus of claim 1, comprising:
a hierarchy component for execution by the circuitry to maintain a data path between each LVM such that a network hierarchy is established to enable failover between at least a first LVM arranged to provide a first RAID service to a second LVM also arranged to provide the first RAID service if a logical server hosting the first LVM fails or is no longer capable of supporting the first LVM.

7. The apparatus of claim 6, the hierarchy component to also maintain the data path using the network hierarchy to reconfigure the data path between the first LVM and the second LVM responsive to a failure of a first data link between the first and second LVMs.

8. The apparatus of claim 7, comprising the failure of the logical server hosting the first LVM or the failure of the first data link is based on a reliability, availability and serviceability (RAS) event defined, at least in part, in the received information for the data service.

9. The apparatus of claim 6, the data path comprising a transmission control protocol/internet protocol (TCP/IP) based network data path or a fabric based network data path.

10. The apparatus of claim 1, the shared pool of configurable computing resources comprising disaggregate physical elements including central processing units, memory devices, storage devices, network input/output devices or network switches.

11. The apparatus of claim 1, comprising a digital display coupled to the circuitry to present a user interface view.

12. A method comprising:
receiving, at a processor circuit, information for a data service being provided using a shared pool of configurable computing resources, the data service including redundant array of independent disks (RAID) services; and
composing a plurality of logical servers such that each logical server includes at least a portion of the shared pool of configurable computing resources, the plurality of logical servers capable of separately hosting a logical volume manager (LVM) capable of providing a separate RAID service using at least a portion of the shared pool of configurable computing resources included with a respective logical server that hosts each LVM, the separate RAID service provided by each LVM based, at least in part, on the received information.

13. The method of claim 12, the received information for the data service including a service level agreement or service level objective for one or more customers of the data service.

14. The method of claim 12, comprising:
maintaining a data path between each LVM such that a network hierarchy is established to enable failover between at least a first LVM arranged to provide a first RAID service to a second LVM also arranged to provide the first RAID service if a logical server hosting the first LVM fails or is no longer capable of supporting the first LVM.

15. The method of claim 14, maintaining the data path using the network hierarchy to reconfigure the data path between the first LVM and the second LVM responsive to a failure of a first data link between the first and second LVMs.

16. The method of claim 15, comprising the failure of the logical server hosting the first LVM or the failure of the first data link is based on a reliability, availability and serviceability (RAS) event defined, at least in part, in the received information for the data service.

17. The method of claim 12, the shared pool of configurable computing resources comprising disaggregate physical elements including central processing units, memory devices, storage devices, network input/output devices or network switches.

18. At least one machine readable medium comprising a plurality of instructions that in response to being executed by system cause the system to:
receive information for a data service being provided using a shared pool of configurable computing resources, the data service including redundant array of independent disks (RAID) services; and
compose a plurality of logical servers such that each logical server includes at least a portion of the shared pool of configurable computing resources, the plurality of logical servers capable of separately hosting a logical volume manager (LVM) capable of providing a separate RAID service using at least a portion of the shared pool of configurable computing resources included with a respective logical server that hosts each LVM, the separate RAID service provided by each LVM based, at least in part, on the received information.

19. The at least one machine readable medium of claim 18, the received information for the data service including a service level agreement or service level objective for one or more customers of the data service.

20. The at least one machine readable medium of claim 18, comprising the instructions to further cause the system to:
configure at least some of the LVMs to provide RAID services having different redundancy characteristics such that a first LVM provides a first RAID service having a first RAID level and a second LVM provides a second RAID service having a second, different RAID level.

21. The at least one machine readable medium of claim 18, the instructions to cause the system to compose the plurality of logical servers comprise the instructions to also cause the system to:
configure at least some of the logical servers such that a first logical server hosting a first LVM capable of providing a first RAID service is arranged to be a hot spare for a second logical server hosting a second LVM currently providing the first RAID service.

22. The at least one machine readable medium of claim 18, comprising the instructions to further cause the system to:
configure at least some of the LVMs to provide RAID services having different redundancy characteristics such that a first LVM provides a first RAID service having a first volume expansion and a second LVM provides a second RAID service having a second, different volume expansion.

23. The at least one machine readable medium of claim 18, comprising the instructions to further cause the system to:
maintain a data path between each LVM such that a network hierarchy is established to enable failover between at least a first LVM arranged to provide a first RAID service to a second LVM also arranged to provide the first RAID service if a logical server hosting the first LVM fails or is no longer capable of supporting the first LVM.

24. The at least one machine readable medium of claim 18, the shared pool of configurable computing resources comprising disaggregate physical elements including central processing units, memory devices, storage devices, network input/output devices or network switches.

25. The at least one machine readable medium of claim 24, the instructions to cause the system to provide the separate RAID service using the at least the portion of the shared pool of configurable computing resources included with the respective logical server that hosts each LVM comprises the at least a portion including one or more storage devices arranged as a solid state drive or a hard disk drive.
